(19) United States
(12) Patent Application Publication
(10) Pub. No.: US 2020/0139385 A1
(43) Pub. Date: May 7, 2020

(54) AEROSOL NOZZLE ASSEMBLY AND NOZZLE CUP MEMBER FOR SPRAYING VISCOUS NEWTONIAN FLUIDS

(71) Applicant: DLHBOWLES, INC., Canton, OH (US)

(72) Inventors: Evan HARTRANFT, Bowie, MD (US); Timothy CURRIE, Washington, DC (US); Samuel L. BERNSTEIN, Riva, MD (US)

(21) Appl. No.: 16/671,939

(22) Filed: Nov. 1, 2019

Related U.S. Application Data
(60) Provisional application No. 62/755,141, filed on Nov. 2, 2018.

(51) Int. Cl. B05B 1/14; B05B 1/10

(52) U.S. Cl. CPC B05B 1/14; B05B 1/10

(57) ABSTRACT

Provided is a cup shaped nozzle member and dispensing package assembly for dispensing or spraying a pumped or pressurized fluid drawing from a transportable container to generate a spray of fluid. The cup-shaped nozzle member mounted in said dispensing package and including a plurality of interaction chambers defined within the distal end wall wherein each interaction chamber defines a fluid channel that terminates distally in an exit orifice. At least one distally projecting platform rib member spaced from and proximate to said first discharge orifice along an outer surface of the distal end wall, wherein said distally projecting platform rib member has a selected distally projecting length which is at least as great as the length of the first distally projecting protuberance.

### CROSS-REFERENCE TO RELATED APPLICATIONS

This application claims the benefit of priority to U.S. Provisional Application No. 62/755,141 titled “Aerosol Nozzle Assembly and Nozzle Cup Member for Spraying Viscous Newtonian Fluids” filed on Nov. 2, 2018. The application is related to commonly owned U.S. PCT patent application number PCT/US15/58947, entitled “Spray Nozzle for High Viscosity (e.g., Oil) Spray Applications with Uniform Spray Distribution” (and published as WIPO Publ. WO/2016/077114). This application is also related to commonly owned U.S. Pat. No. 7,354,008, entitled “Fluidic Nozzle for Trigger Spray Applications”, and PCT application number PCT/US12/34293, entitled “Cup-shaped Fluidic Circuit, Nozzle Assembly and Method” (published as WIPO Publ. WO 2012/145537). The entire disclosures of all of the foregoing are hereby incorporated herein by reference.

### FIELD OF APPLICATION

The present application relates, in general, to spray nozzles configured for use when spraying or dispensing viscous Newtonian fluids packaged as consumer goods such as lubricating fluids, cooking or other oils, personal care products and the like.

### BACKGROUND

Generally, a trigger dispenser for spraying consumer goods is a relatively low-cost pump device for delivering liquids from a container. The dispenser is held in the hand of an operator and has a trigger that is operable by squeezing or pulling the fingers of the hand to pump liquid from the container and through a spray head incorporating a nozzle at the front of the dispenser.

Such manually-operated dispensers may have a variety of features that have become common and well known in the industry. For example, a prior art dispenser may incorporate a dedicated spray head having a nozzle that produces a defined spray pattern for the liquid as it is dispensed or issued from the nozzle. It is also known to provide nozzles having adjustable spray patterns so that with a single dispenser the user may select a spray pattern that is in the form of either a stream or a substantially circular or conical spray of liquid droplets.

Many substances are currently sold and marketed as consumer goods in containers with such trigger-operated spray heads, as shown in FIG. 1A. Examples of such substances include air fresheners, window cleaning solutions, carpet cleaners, spot removers, personal care products, weed and pest control products, and many other materials useful in a wide variety of spraying applications. Consumer goods using these sprayers are typically packaged with a bottle that carries a dispenser which typically includes a manually actuated pump that delivers a fluid to a spray head nozzle which a user aims at a desired surface or in a desired direction. For fluids of thicker viscosity, these prior art spray heads typically include spray nozzles that may only generate a fluid jet, or not work at all.

Aerosol applications are also common and now use Bag-On-Valve (“BOV”) and compressed gas methods to develop higher operating pressures, (e.g., in the range of 30-140 PSI), rather than the previously-used costly and less environmentally friendly propellants. These packaging methods are desired because they can produce higher operating pressures compared to the other delivery methods, as mentioned above.

Other gas pressure driven dispensing systems use pressurized air as the propellant, such as the Airopack™ brand system described in US published applications 2016/0159556 (for dispensing foam) and 2018/0148248 (for dispensing fluids). These popular, environmentally friendly product delivery systems are finding widespread acceptance for a number of products but are not easily employed when dispensing certain products.

Some commercial products are packaged with dispensers configured to generate a product spray in a selected spray pattern. The nozzles for typical commercial dispensers (see, e.g., FIGS. 1B and 1C) are typically of the molded “cap” variety, having channels producing selected spray or stream patterns when the appropriate channel is lined up with a feed channel coming out of a sprayer assembly. Some of these prior art nozzles (e.g., 30) are traditionally referred to as flat fan spray shear nozzles inasmuch as the spray they generate is generally sheared within the nozzle assembly to form a flat fan spray (as opposed to a stream) having droplets of varying sizes and velocities scattered across a wide angle. Traditional flat fan spray nozzles (e.g., 30, as shown in FIGS. 1C and 1D) consist of a converging fluid channel or feed which is distally terminated in a slot-shaped exit orifice 34 defined by spaced, parallel, first and second opposing fluid flow shearing lips L1, L2 or edges. These nozzles work well for some, but not all, product fluids.

For many consumer product fluids, the traditional flat fan spray nozzle 30 generates an acceptable and substantially planar flat fan spray with the plane of the spray fan being parallel with, and between, the exit orifice's spaced, parallel, first and second opposing fluid flow shearing lips L1, L2, where the fan width is partly a function of the nozzle feed width FW and the thickness of the spray fan is partly a function of the fluid feed channel's convergence angle β (β, best seen in FIG. 1D). These traditional flat fan spray shear nozzles are not suitable for all Newtonian fluid spraying applications, however. Many products are dispensed with other spray patterns. Some product dispensers benefit from a spray that is formed from multiple straight jets, and generating such sprays with viscous, Newtonian fluids can be challenging, especially if the dispensing nozzle assembly is to be manufactured in a manner which provides a durable product that can be manufactured in economically reasonable quantities at reasonable costs.

In the Applicants' recent development work for a particular kind of viscous fluid nozzle assembly, the prior art nozzle assemblies (e.g., of FIG. 1A-1D) were not providing satisfactory sprays. High viscosity, Newtonian fluids like oils and lubricants are extremely difficult to spray, especially at lower pressures (<40 psig). Mechanical breakup (MBU) nozzles such as swirl atomizers, shear nozzles, and fluidics, are not capable of reliably producing any kind of satisfactory dispersed spray other than straight jets, especially at flow rates desired for typical consumer products like olive oil and personal care products. There is a need for a durable nozzle assembly which reliably generates a spray of multiple straight jets of a Newtonian fluid product and which can be manufactured economically in commercially reasonable quantities.

### SUMMARY

The applicants have studied the prior art nozzle assemblies (e.g., as illustrated in FIGS. 1A-1D) and identified why those prior art nozzle assemblies are unsuitable for use with product dispensing or spraying applications which require the dispensing nozzle assembly to be manufactured in a manner which provides a durable product that can be manufactured in economically reasonable quantities at reasonable costs.

As noted above, high viscosity, Newtonian fluids like oils and lubricants are extremely difficult to spray, especially at lower pressures (<40 psig). Mechanical breakup (MBU) nozzles, such as swirl atomizers, shear nozzles, and fluidics, are not capable of producing any kind of spray other than straight jets, especially at flow rates desired for typical consumer products like olive oil and personal care products, so development work for a more suitable nozzle assembly was undertaken. To spray Newtonian fluids like olive oil (40-80 cP), ingredients are added to reduce the viscosity and improve the overall ability to spray. Examples include liquid propellant (i.e. Butane, Propane) for LPG aerosol applications and alcohol for non-LPG applications. High pack pressures are also used to improve the ability to spray (70-130 psig). Low pressure systems like the Airopack™ system operate at 20-40 psig, which make the ability to spray these kinds of fluids even more difficult. As a result of these observations, the Applicants started their development efforts by making prototype nozzle cup members with multiple outlets with diameters between 0.005″ and 0.015″, and in testing these prototypes, it was discovered that a residual fluid film that remains on or around the face/exit of the nozzle can prevent the jets from forming because they cannot overcome the intermolecular forces of the fluid film (viscosity and surface tension). This film residue issue seemed to define a bottom limit for how small the exit orifice holes can be for a specific number of holes, available pressure, and fluid viscosity. To solve this film residue issue, the applicants added exit orifice defining distally projecting protuberances so that the exit orifices of the nozzle are distally offset from the plane of the distal surface or “face” of the nozzle cup member, where the residual fluid film is present.

In further development work, applicants discovered that it is very difficult to reliably manufacture a fluid cup nozzle member with multiple small holes, with the exit orifices defined in the distally projecting protuberances. In an injection molding process, steel pins smaller than 0.010″ that need to shut off are very challenging to create, and keeping the wall thickness uniform and acceptable with the protuberances is very challenging.

The development work led the Applicants to develop a nozzle configuration and molding method which functioned surprisingly well because two problems were identified and addressed, namely:
1. Exact hole diameters, number of holes, throat length, interaction region, and protuberance geometry are carefully tuned for each specific fluid viscosity, for example, a 30 psig system that requires a flow rate less than one g/s.
2. The biggest innovation relates to overcoming the viscous forces from the residual fluid film on or around the nozzle exit.
a. The flow rate and velocity of each outlet is a function of the design because the amount of momentum of the jet of fluid may overcome the resistance created by the residual fluid.
b. The protuberance geometry is a function of the design because it assists to reduce the presence of the residual fluid film directly on or around the nozzle outlet. However, protuberances that are too long may be undesirable because of manufacturing and throat length constraints.

Alternative embodiments incorporating the improvements of the present application are possible, but many of the identified dimensions are adjusted for each fluid and available pressure. For example, for lower viscosities, (<50 cP in some applications or <100 cP), the nozzle cup member can have more outlets (e.g., 7 or more), while for higher viscosities, (>50 cP or >100 cP), the practical limit now appears to be limited to about 6 outlets (for inlet pressures of 30 psi).

For the aerosol nozzle assembly and the nozzle cup member for spraying viscous Newtonian fluids of the present application, the spray generated is a combination of multiple (e.g., three) straight jets. The factors that ensure that the amount of momentum of the fluid leaving the nozzle in the distally projecting jets overcomes any viscous forces from the residual fluid film on or around the outlet include: outlet length and diameter, number of outlets, protuberance distal length and diameter, fluid product viscosity, and surface tension. In the illustrated embodiment, the nozzle cup member's individual nozzle orifices each have a selected interaction region length, protuberance length, and throat length which have been designed to provide better manufacturability (e.g., when injection molded). Each Newtonian fluid requires a different configuration of dimensional parameters to achieve a desirable spray performance.

The Applicants have undertaken significant research and development work with the goal of providing a nozzle to spray the subject Newtonian fluids or liquids at lower pressures (e.g., 30 PSI). This development work also sought to develop a nozzle cup member for spraying a desired spray pattern or spray distribution from multiple jets with the subject liquids in a nozzle configuration with protective distally projecting rib or platform features which will also ensure that each outlet's protuberance remains in its original configuration, and is not crushed or deformed by external forces before the product package is emptied of the fluid product.

In one embodiment, provided is a cup shaped nozzle member and dispensing package assembly for dispensing or spraying a pumped or pressurized fluid drawing from a transportable container to generate a spray of fluid. The assembly comprises an actuator body having a distally projecting sealing post having a post peripheral wall terminating at a distal or outer face, said actuator body including a fluid passage communicating with a lumen. A cup-shaped nozzle member mounted in said actuator body having a peripheral wall extending proximally into a bore in said actuator body radially outwardly of said sealing post and having a distal end wall comprising an inner surface opposing said sealing post to define a fluid channel, said cup-shaped nozzle member including a plurality of interaction chambers defined within the distal end wall wherein each interaction chamber defines a fluid channel that terminates distally in an exit orifice. The interaction chambers being in fluid communication with said actuator body's fluid passage wherein a first exit orifice has a selected diameter and is defined in a first distally projecting protuberance having a selected protuberance length and a selected protuberance diameter. At least one distally projecting platform rib member spaced from and proximate to said first discharge orifice along an outer surface of the distal end wall, wherein said distally projecting platform rib member has a selected distally projecting length which is at least as great as the length of the first distally projecting protuberance. Said cup shaped member includes three exit orifices, each aimed from distally projecting protuberances which are radially arrayed on the distal end wall and three distally projecting protective ribs. Said cup shaped nozzle member is configured to spray viscous fluid for higher viscosity fluid over 50 cP having an inlet pressure of approximately 30 psi. The plurality of exit outlets have a throat diameter between about 0.005″ and 0.010″, separated by distally projecting protuberances which distally offset the exit orifices from a plane of the outer surface of the distal end wall, to reduce the presence of the residual fluid film directly on or around the exit outlet. The cup shaped nozzle member includes a substantially cylindrical sidewall that surrounds a central longitudinal spray axis aligned with said sealing post member, wherein said sidewall terminates distally in the distal end wall having an interior surface with three distally aimed exit outlets and interaction chambers, wherein each provide fluid communication between an interior and exterior of the nozzle member. Said interaction region includes a proximal lumen segment and an axially aligned, distally narrowing, contiguous region defined by a converging fluid feed channel wall segment that terminates distally in said exit outlet, the exit outlet having a throat length. Said interaction region is at least partially defined within said distally projecting protuberance such that the distally projecting protuberance includes a distal annular surface having a diameter which terminates radially in a rounded shoulder sidewall segment to define a protuberance length and a protuberance diameter. The proximal lumen segment is generally cylindrical and includes a length that extends from the interior surface through a portion of the distal end wall. The lumen segment is adjacent to the axially aligned, distally narrowing, contiguous region at a position within the distal end wall before the protuberance extends from the outer surface of the distal end wall. The fluid feed channel wall segment may be symmetrically shaped or asymmetrically shaped.

In another embodiment, provided is a cup-shaped nozzle member configured to dispense viscous fluids from a dispensing package assembly, the cup-shaped nozzle member including a cylindrical sidewall that defines an interior volume and extends from a proximal open end to a distal end wall, the distal end wall comprising an inner surface including a plurality of interaction chambers defined within the distal end wall, wherein each interaction chamber defines a fluid channel that terminates distally in an exit orifice, said interaction chambers being in fluid communication with said interior volume. A first exit orifice has a selected diameter and is defined in a first distally projecting protuberance having a selected protuberance length and a selected protuberance diameter and at least one distally projecting platform rib member spaced from and proximate to said first exit orifice along an outer surface of the distal end wall, wherein said distally projecting platform rib member has a selected distally projecting length which is at least as great as the length of the first distally projecting protuberance. The plurality of exit outlets have a throat diameter between about 0.005″ and 0.010″, and the projecting protuberances distally offset the exit orifices from a plane of the outer surface of the distal end wall, to reduce the presence of the residual fluid film directly on or around the exit outlet. The interaction region includes a proximal lumen segment and an axially aligned, distally narrowing, contiguous region defined by a converging fluid feed channel wall segment that terminates distally in said exit outlet, the exit outlet having a throat length wherein said interaction region is at least partially defined within said distally projecting protuberance such that the distally projecting protuberance includes a distal annular surface having a diameter which terminates radially in a rounded shoulder sidewall segment to define a protuberance length and a protuberance diameter. Said proximal lumen segment is generally cylindrical and includes a length that extends from the interior surface through a portion of the distal end wall. Said lumen segment is adjacent to the axially aligned, distally narrowing, contiguous region at a position within the distal end wall before the protuberance extends from the outer surface of the distal end wall. Said fluid feed channel wall segment is symmetrically shaped or frusto-conically shaped or has an asymmetric shape. The portion of the interaction region defined by the lumen segment includes a length that is greater than a length of the distally narrowing, contiguous region, wherein the length of the distally narrowing, contiguous region is greater than a length of the throat length.

In yet another embodiment, provided is a cup-shaped nozzle member configured to dispense viscous fluids from a dispensing package assembly, the cup-shaped nozzle member comprising a cylindrical sidewall that defines an interior volume and extends from a proximal open end to a distal end wall, the distal end wall comprising an inner surface including a plurality of interaction chambers defined within the distal end wall, wherein each interaction chamber defines a fluid channel that terminates distally in an exit orifice, said interaction chambers being in fluid communication with said interior volume. A first exit orifice has a selected diameter and is defined in a first distally projecting protuberance having a selected protuberance length and a selected protuberance diameter. At least one distally projecting platform rib member spaced from, and proximate to, said first exit orifice along an outer surface of the distal end wall, wherein said distally projecting platform rib member has a selected distally projecting length which is at least as great as the length of the first distally projecting protuberance. Said interaction region includes a proximal lumen segment and an axially aligned, distally narrowing, contiguous region defined by a converging fluid feed channel wall segment that terminates distally in said exit outlet, the exit outlet having a throat length. Said interaction region is at least partially defined within said distally projecting protuberance such that the distally projecting protuberance includes a distal annular surface having a diameter which terminates radially in a rounded shoulder sidewall segment to define a protuberance length and a protuberance diameter. The portion of the interaction region defined by the lumen segment includes a length that is greater than a length of the distally narrowing contiguous region. The length of the distally narrowing contiguous region is greater than a length of the throat length.

With the foregoing exemplary embodiments, it is an object of the present application to provide a cost effective aerosol nozzle assembly and cup shaped nozzle member for spraying viscous Newtonian fluids which will, for viscous products, reliably generate a substantially uniform multiple jet spray.

### DESCRIPTION OF THE DRAWINGS

These, as well as other objects and advantages of this application, will be more completely understood and appreciated by referring to the following more detailed description of the presently preferred exemplary embodiments of the application in conjunction with the accompanying drawings, of which:

FIG. 1A illustrates the spray head of a manual-trigger spray applicator in accordance with the prior art;

FIG. 1B illustrates typical features of a prior art aerosol spray actuator having a traditional flat fan spray shear nozzle;

FIG. 1C is a plan view that illustrates typical features of a prior art flat fan spray shear nozzle member's internal geometry and exit orifice geometry;

FIG. 1D is a cross sectional side view of FIG. 1C that illustrates typical features of a prior art flat fan spray shear nozzle member's internal geometry and exit orifice geometry;

FIG. 2 is a perspective view illustrating a three-jet spray generating a cup-shaped nozzle member which includes first, second and third distally projecting exit orifices or outlets radially arrayed with alternating distally projecting protective platform or rib segments, in accordance with the present application;

FIG. 3A is a cross sectional view of the cup-shaped nozzle member of FIG. 2 with each exit orifice's interaction region and throat geometry defining a longitudinal spray axis, in accordance with the present application;

FIG. 3B is an enlarged cross sectional view of a portion of FIG. 3A;

FIG. 4 is a perspective front view of the cup-shaped nozzle member in accordance with the present application;

FIG. 5 is a perspective rear view of the cup-shaped nozzle member in accordance with the present application;

FIG. 6 is a front plan view of the cup-shaped nozzle member in accordance with the present application;

FIG. 7 is a front perspective view of the cup-shaped nozzle member in accordance with the present application;

FIG. 8 is a rear plan view of the cup-shaped nozzle member in accordance with the present application;

FIG. 9 is a perspective rear view of the cup-shaped nozzle member in accordance with the present application;

FIG. 10A is a side view of the cup-shaped nozzle member in accordance with the present application;

FIG. 10B is a side cross sectional view of the cup-shaped nozzle member of FIG. 10A;

FIG. 10C is an enlarged cross sectional view of a portion of FIG. 10B;

FIG. 11 is a partial perspective view of an embodiment of a cup-shaped nozzle member having individual orifice axes which are not parallel with the cup member's central axis to create different product sprays, in accordance with the present application;

FIG. 12 is a cross-sectional view of the cup-shaped nozzle member of FIG. 11;

FIG. 13 is a front plan view of the embodiment of the cup-shaped nozzle member of FIG. 11;

FIG. 14 is a perspective view in cross-section of an embodiment of a cup-shaped nozzle member attached to a spray assembly according to the present disclosure;

FIG. 15 is a front plan view of another embodiment of a cup-shaped nozzle member according to the present disclosure;

FIG. 16 is a cross sectional view of the cup-shaped nozzle member of FIG. 15; and

FIG. 17 is a partial perspective view of the cup-shaped nozzle member of FIG. 15.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, any identification of specific shapes, materials, techniques, arrangements, etc. are either related to a specific example presented or are merely a general description of such a shape, material, technique, arrangement, etc.

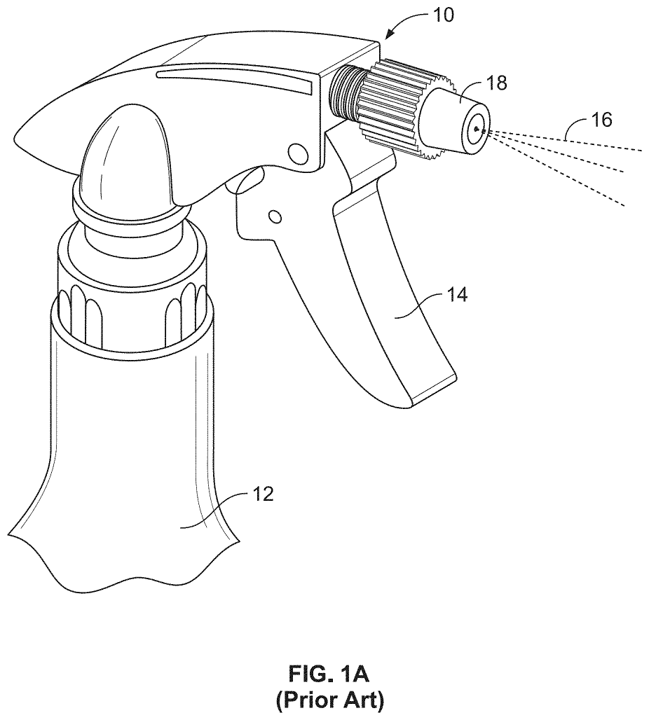

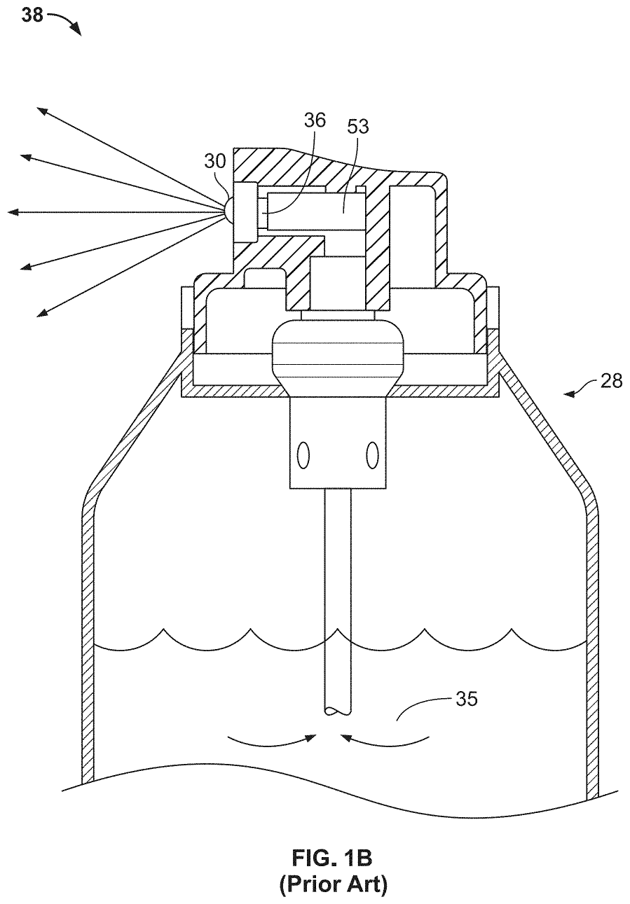

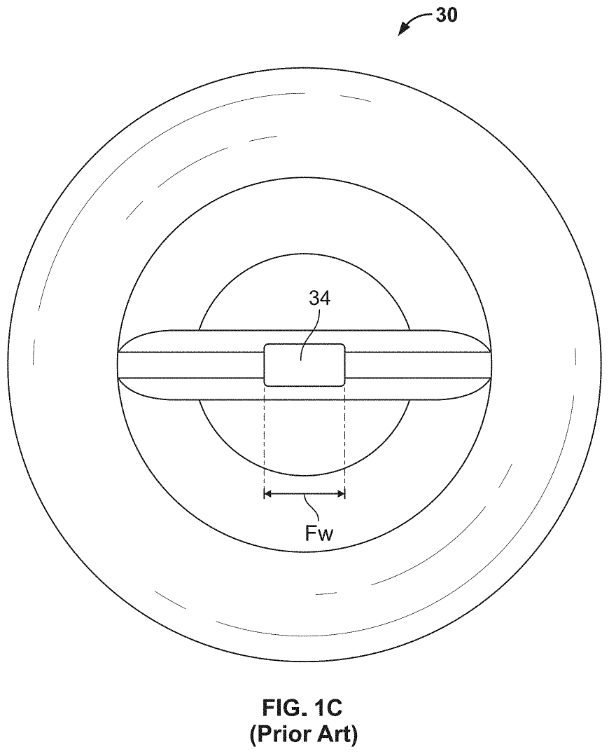

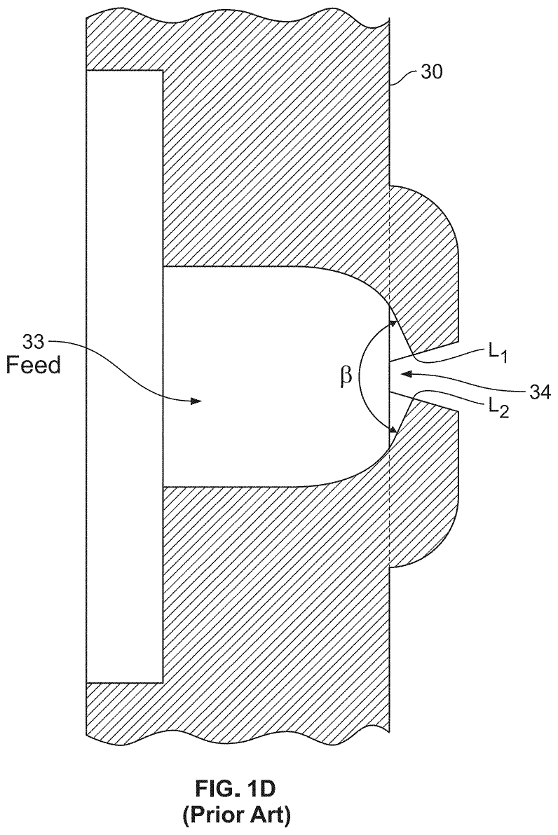

Referring now to the Figures, wherein common elements are identified by the same numbers, FIG. 1A illustrates a typical manually-operated trigger pump 10 secured to a container 12 of fluid to be dispensed, wherein the pump incorporates a trigger 14 activated by an operator to dispense fluid 16 through a nozzle 18. Such dispensers are commonly used, for example, to dispense a fluid from the container in a defined spray pattern or as a stream. Adjustable spray patterns may be provided so that the user may select either a stream or one of a variety of sprayed fluid droplets. A typical nozzle 18 consists of tubular conduit that receives fluid from the pump and directs it into a spray head portion, where the fluid travels through channels and is ejected from an orifice, or aperture. Such devices are constructed as a one-piece molded plastic “cap” with channels that line up with the pump outlet to produce the desired stream or spray of a variety of fluids at pressures generally in the range of 30 to 40 PSI, if spraying a fluid which is not significantly more viscous than water.

FIGS. 1B and 1C illustrate a typical commercial aerosol dispenser 28 configured with a traditional flat fan spray nozzle member configured as a cup shaped member 30. These standard cup-shaped nozzle members 30 have an interior surface which abuts and seals against a face seal on a planar circular surface of the distally projecting sealing post 36 and are arranged so that the flow of product fluid 35 flows into and through an annular lumen into the fluid feed or input channel and then flows distally into the central converging region. The fluid product flows distally or downstream and leaves the converging region through an exit orifice of a cup shaped nozzle member 30 which is typically concentric to the central axis of the sealing post 36. For viscous liquid products, the fluid product spray 38 issuing from or generated by the standard nozzle assembly sprays a non-uniform pattern of liquid droplets as described above. These viscosity dependent problems were analyzed by the Applicants, who have discovered that parts of the standard nozzle assemblies of the spray dispensers 10, 28 can be used for spraying viscous products, but only if a newly developed nozzle configuration is also used.

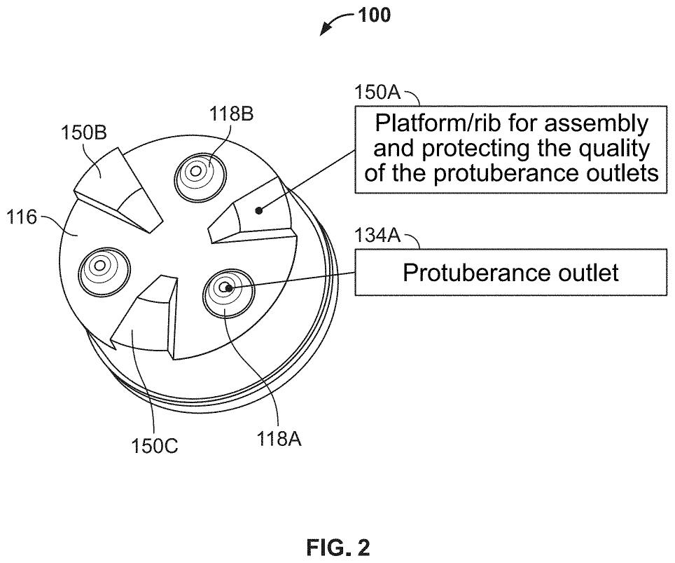

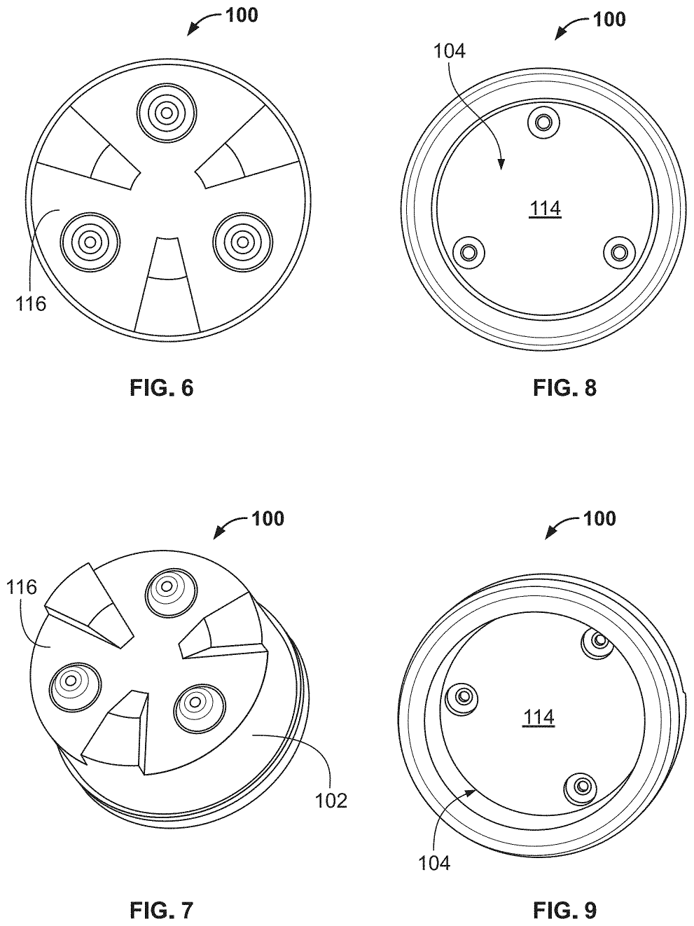

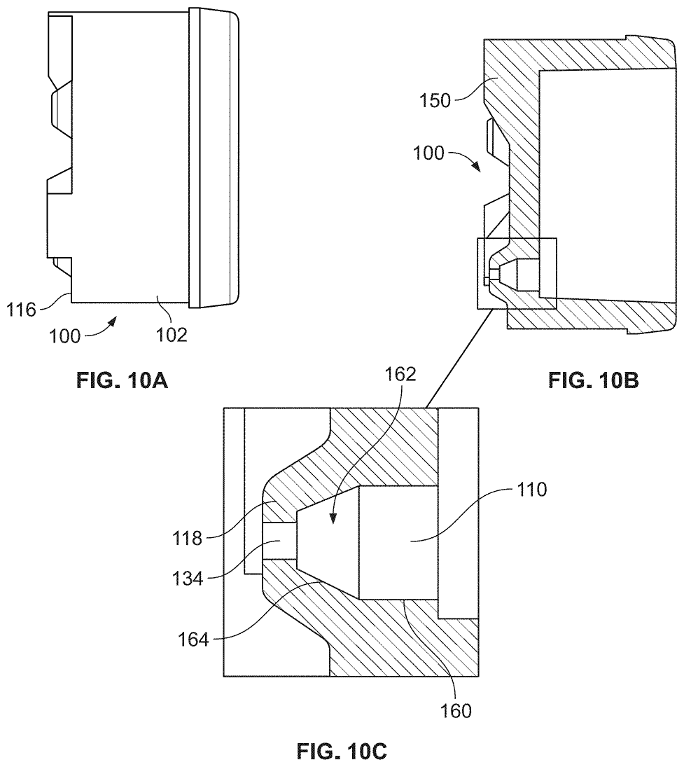

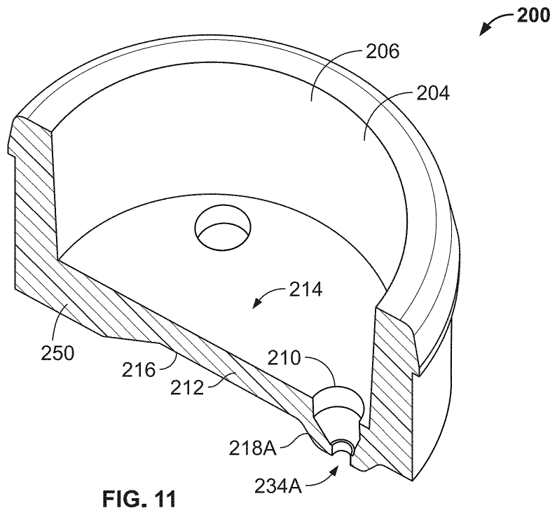

To overcome the problems found in prior art sprayers of FIGS. 1A-1D, in accordance with the present application, a new nozzle assembly is configured for use with the spray head and sealing post structure of standard nozzle assemblies, but discards the flawed performance of the standard cup-shaped nozzle member (e.g., 30). Thus, the present application is directed to a new nozzle configuration, illustrated in FIGS. 2-17, including a cup shaped nozzle member 100 which permits significantly improved control of the subject high viscosity fluids (i.e., oils, sunscreen lotions, other lotions, cleaning liquids, shear-thinning liquids and gels and similar Newtonian and non-Newtonian fluids having viscosities of 10-300 cP), and permits the configuration of a selected number (e.g. three) of jet spray generating nozzle orifices which will reliably generate substantially uniform jet sprays, even at low pressure.

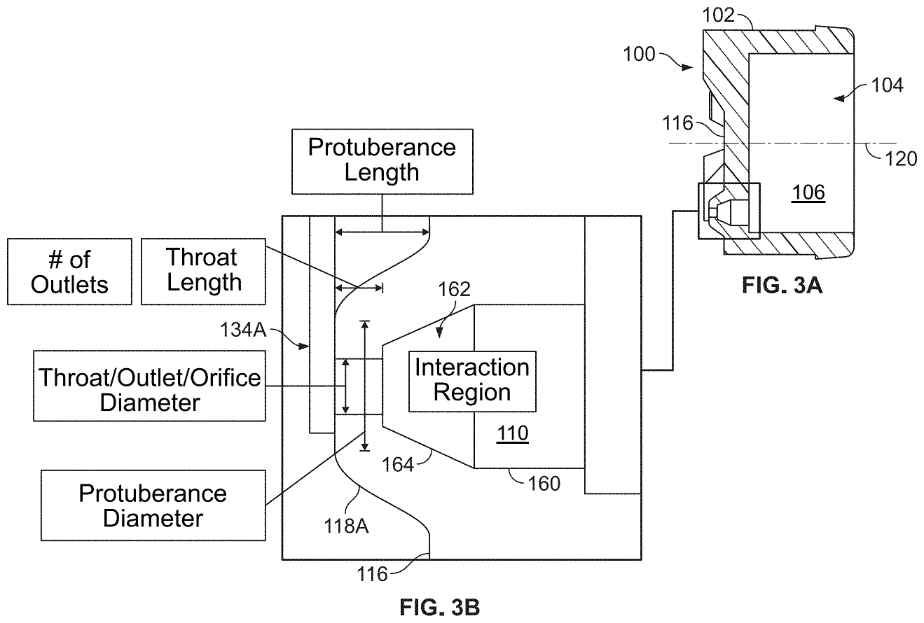

Referring initially to FIGS. 2, 3 and 3A, the cup shaped nozzle member 100 has three exit orifices 134A, 134B, 134C, each aimed from distally projecting protuberances 118A, 118B, 118C, which are radially arrayed on a distal end wall 116 along with three distally projecting protective ribs 150A, 150B, 150C to define an array of three exit orifices 134, each separated by surrounding protective ribs, all of which project distally from the planar outer surface 112.

Referring next to the views of the cup-shaped three-jet spray generating nozzle member 100, configured for use with spray-type dispensers (e.g., as shown in FIG. 1A or 1B) in which viscous fluid products flow into and through a feed channel or feed lumen defined in the interior volume of cup member 100 within the substantially cylindrical sidewall 102, which surrounds a central longitudinal spray axis 120, which intersects the transverse plane of the outer surface 112 of distal end wall 116, the cup shaped nozzle member 100 defines an interior surface which abuts and seals against a face seal on a typical planar circular surface of distally projecting sealing post 36, and is arranged so that the flow of product fluid (e.g., 35) flows into and through annular lumen into the fluid feed or input channel 33 and then flows distally each of the interaction regions 110 defined in cup member 100 (as described in more detail, below). The cup-shaped nozzle member's cylindrical sidewall 102 has an open proximal end 104 defining the upstream end of an interior volume 106.

The cylindrical sidewall 102 terminates distally in an interior surface 114 of the distal end wall that may be substantially circular in shape. The outer surface 112 of the distal end wall 116 includes (in the illustrated example) three outlets or exit apertures 134A, 134B, 134C which provide fluid communication between the interior 106 and exterior of the cup shaped nozzle member 100. There may be more than three exit orifices in a nozzle assembly or for use with a dispenser, but for purposes of describing the nozzle geometry of the present application, the exemplary nozzle member 100 includes at least the three illustrated exit orifices 134A, 134B, 134C passing through the distal end wall 116, and each exit orifice is defined around an orifice axis which is preferably parallel with the first central longitudinal spray axis 120 and provides fluid communication between said nozzle member's interior fluid channel 106 and the ambient space beyond the outer surface 112. As best seen in FIG. 3A, each exit orifice (e.g., 134A) is a substantially cylindrical lumen with a throat/outlet/orifice internal diameter dimension being aligned with its corresponding interaction region which is defined in interior surface 114.

Each of the three nozzle orifices is aligned with a dedicated and axially aligned interaction region 110 defined in the interior surface 114 of the distal end wall 116 to provide a jet spray generating structure which includes distinct, contiguous fluid feed channel wall segments.

As noted above, high viscosity, Newtonian fluids like oils and lubricants are extremely difficult to spray, especially at lower pressures (<40 psig). Mechanical breakup (MBU) nozzles, such as swirl atomizers, shear nozzles, and fluidics, are not capable of producing any kind of spray other than straight jets, especially at flow rates desired for typical consumer products like olive oil and personal care products, so development work for a more suitable nozzle assembly was undertaken. To spray Newtonian fluids like olive oil (40-80 cP), ingredients are added to reduce the viscosity and improve the overall ability to spray. Examples include liquid propellant (i.e. Butane, Propane) for LPG aerosol applications and alcohol for non-LPG applications. High pack pressures are also used to improve the ability to spray (70-130 psig). Low pressure systems like the Airopack™ system operate at 20-40 psig, which make the ability to spray these kinds of fluids even more difficult. For purposes of background and nomenclature, Airopack™ U.S. published applications 20160159556 (for dispensing foam) and 20180148248 (for dispensing fluids) are incorporated herein by reference. As a result of these observations, the Applicants started their development efforts by making prototype nozzle cup members with multiple outlets (e.g., 134A, 134B, 134C) with diameters between 0.005″ and 0.010″. In testing these prototypes, it was discovered that a residual fluid film that remains on or around the face/exit of the nozzle can prevent the jets from forming, because they cannot overcome the intermolecular forces of the fluid film (viscosity and surface tension). This film residue issue seemed to define a bottom limit for how small the exit orifice holes can be for a specific number of holes, available pressure, and fluid viscosity. In cup shaped nozzle member 100, this film residue issue is solved by the added exit orifice defining distally projecting protuberances (e.g., 118A, 118B, 118C), which distally offset the exit orifices of the nozzle from the plane of the outer surface 112, or face of the distal end wall 116 of the cup shaped nozzle member 100 where the residual fluid film remains present.

In the Applicants' manufacturing process development work, the Applicants discovered that it is very difficult to reliably manufacture a cup shaped nozzle member with multiple small exit orifices (e.g., 134A, 134B, 134C) defined in the distally projecting protuberances (e.g., 118A, 118B, 118C) because in an injection molding process, steel pins smaller than 0.010″ that need to shut off are very challenging to create, and keeping the wall thickness uniform and acceptable with the protuberances is very challenging.

The development work led the Applicants to develop a nozzle configuration and molding method which functioned surprisingly well because two problems were identified and addressed, namely:

1. Exact hole diameters, number of holes, throat length, interaction region, and protuberance geometry (e.g., as illustrated in FIGS. 2-3A) are carefully tuned for each specific fluid viscosity (e.g., for a 30 psig system that requires a flow rates <1 g/s).

2. Overcoming the fluid film residue issue (i.e., where viscous forces from the residual fluid film on or around the nozzle exit adversely alter the emitted jets sprayed from the orifices, unless the orifices (e.g., 134A, 134B, 134C) are distally offset.
a. The flow rate and velocity of each outlet (e.g., 134A, 134B, 134C) is a feature of this disclosure because each fluid jet being sprayed has enough momentum to overcome the resistance created by the residual fluid.
b. The protuberance geometry (e.g., 118A, 118B, 118C) is a feature of this disclosure because it is configured to reduce the presence of the residual fluid film directly on or around the nozzle outlet, but it also can't be too long because of manufacturing and throat length constraints.

Alternative embodiments incorporating the improvements of the present application are possible, but all of the described dimensions may be adjusted for each fluid and available pressure. For example, for lower viscosities (<50 cP), the nozzle cup member can have more outlets (e.g., 7 or more), while for higher viscosities (e.g., >50 cP or about 100-300 cP), the practical limit now appears to be limited to about 6 outlets (for an inlet pressure of approximately 30 psi).

For the aerosol nozzle assembly and the nozzle cup member 100 for spraying viscous Newtonian fluids of the present application, the spray generated is a combination of multiple (e.g., three) straight jets. The factors that are a feature to ensuring the momentum of the fluid leaving the nozzle in the distally projecting jets can overcome any viscous forces from the residual fluid film on or around the outlet include: outlet length and diameter, number of outlets, protuberance distal length and diameter, product viscosity and surface tension. In the illustrated embodiment, nozzle cup member 100 includes the three individual nozzle orifices (e.g., 134A, 134B, 134C), where each has the axially aligned interaction region with a selected interaction region length, protuberance length, and throat length which have been designed to provide better manufacturability (e.g., when injection molded). Each Newtonian fluid product to be dispensed or sprayed requires a different configuration of dimensional parameters to achieve a desirable spray performance.

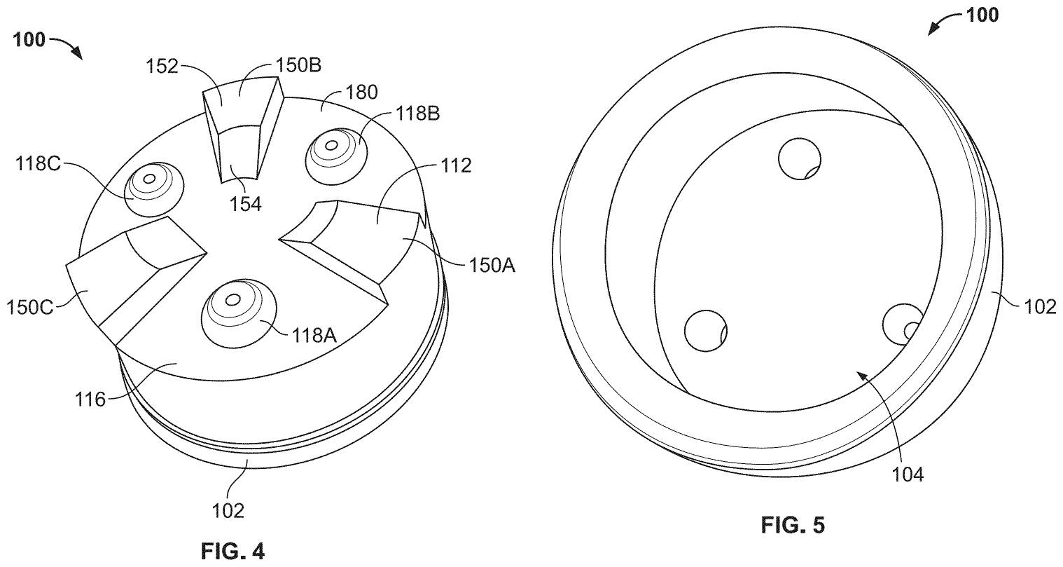

Further, the distally projecting ribs 150 A, B, C may be shaped to include a platform portion 152 adjacent to a ramp portion 154. The platform portion 152 may be generally parallel relative to the outer surface 112 of the distal end wall 116 as illustrated by at least FIG. 4. In an embodiment, the platform portion 152 may have a greater width than the ramp portion 154. Further, the projecting ribs 150 may include a generally tapered profile. The platform portion 152 may be located adjacent to or aligned with an outer perimeter edge 180 of the cup shaped nozzle member 100 while the ramp portion 154 may be located radially inwardly relative to the platform portion 152. In an embodiment, the ribs may each be aligned with the outlet protuberances, wherein first projecting rib 150A is aligned along a common axis with first outlet protuberance 118C; second projecting rib 150B is aligned along a common axis with second outlet protuberance 118A; and third projecting rib 150C is aligned along a common axis with third outlet protuberance 118B as illustrated by FIG. 4. The Applicants' research and development work achieved the goal of providing a nozzle to spray the subject Newtonian fluids or liquids at lower pressures (e.g., 30 PSI), and nozzle cup member 100 reliably sprays a desired spray pattern or spray distribution from multiple jets with the subject liquids in a nozzle configuration with protective distally projecting rib or platform features (e.g., 150A, 150B, 150C), which will also ensure that each outlet's protuberance (e.g., 118A, 118B, 118C) remains in its original configuration, and is not crushed or deformed by external forces before the product package is emptied of the fluid product.

In the illustrated embodiment of the application, the cup-shaped viscous fluid three jet spray generating nozzle member 100 for spray-type dispensers has its substantially cylindrical sidewall 102 surrounding the central longitudinal spray axis 120 which is aligned distally, as is typically required when used with a nozzle assembly having a distally projecting sealing post member (e.g., 36). The cup-shaped nozzle member's cylindrical sidewall terminates distally in the substantially circular distal end wall having an interior surface 114 with a selected number o(e.g., three) of distally aimed outlets, or exit apertures (e.g., 134A, 134B, 134C), which each provide fluid communication between the interior 104 and exterior of the cup (or ambient space).

Defined in the interior surface 114 are the jet-spray generating structures which each include at least a first, second, and third fluid channel interaction region 110A, 110B, 110C which includes a proximal cylindrical lumen segment 160 and an axially aligned, distally narrowing, contiguous region 162 defined by a frusto-conical converging fluid feed channel wall segment 164 converging at an interior wall convergence angle and which terminates distally in its throat/outlet/orifice lumen having an axially aligned distally aimed throat length. The protuberance length may be greater than the throat length. The protuberance diameter is greater than the throat diameter. Each throat/outlet/orifice lumen provides fluid communication between its interaction region 110 and its outlet orifice 134 which opens to ambient space from the distal surface of its distally projecting protuberance end wall. Each distally projecting protuberance (e.g., 118A, 118B, 118C) has a circular planar or distal annular surface having a diameter which terminates radially in a rounded shoulder sidewall segment to define distal protuberance shoulder diameter (as best seen in FIG. 3B).

The proximal lumen segment 160 may be generally cylindrical and include a length that extends from the interior surface 114 through a portion of the distal end wall 116. The lumen segment 160 may abut the axially aligned distally narrowing contiguous region 162 at a point within the distal end wall 116 before the protuberance extends from the outer surface 112 of the distal end wall 116. This configuration can be viewed in FIG. 3A. Notably, fluid feed channel wall segment 164 may be frusto-conical or may have an asymmetric shape to direct the spray through the outlet. The converging at an interior wall convergence angle and which terminates distally in its throat/outlet/orifice lumen having an axially aligned distally aimed throat length.

The configuration of the inner geometry of the interaction region 110 and the throat 134 may play a functional role in the performance of spraying viscous fluids. The portion of the interaction region defined by the lumen segment 160 may have a length that is greater than a length of the distally narrowing contiguous region 162. While the length of the distally narrowing contiguous region 162 may be greater than a length of the throat/outlet/orifice 134. The resulting configuration provides for a geometry of the protuberance 118 having a throat length that is of a small length relative to the remaining portions of the cup shaped nozzle 100 and such a configuration is a challenge to create, particularly when mass produced by injection molding. However, other methods of fabrication are contemplated by this disclosure, including additive manufacturing or 3D printing.

In the configuration seen in FIGS. 2-17, internal threads (not shown) may optionally be included in an internal surface of sidewall 102 at the inlet side or open proximal end 104 the nozzle member 100. The internal threads (if included) are configured to engage with external threads 53 located on the distal end of a discharge of nozzle body 10, 28. Various other mechanical methods of connecting the nozzle member 100 to a dispenser may be used. For example, an alternative method of connecting the nozzle member may be a snap fit type connection.

An alternative embodiment is illustrated in FIGS. 11-13, where another cup-shaped viscous fluid spray generating nozzle member embodiment 200 has individual orifice axes and interaction chambers 210 are not aligned or aimed in parallel with the cup member's central axis which will thus create different product sprays than for cup member 100, in accordance with the present application.

Nozzle cup member 200 has three exit orifices 234A, 234B, 234C each aimed from distally projecting protuberances 218A, 218B, 218C, which are radially arrayed on the distal end wall 216 along with three distally projecting protective ribs 250A, 250B, 250C to defining an array of three exit orifices 234 each separated by surrounding protective ribs, all of which project distally from the planar distal end wall surface 216.

Cup-shaped three-jet spray generating nozzle member 200 is also configured for use with spray-type dispensers (e.g., as shown in FIG. 1A or 1B) in which viscous fluid products flow into and through a feed channel or feed lumen defined in the interior volume of cup member 200 within substantially cylindrical sidewall 202 which surrounds a central longitudinal spray axis 220 which intersects the transverse plane of the outer surface 216 of distal end wall 212. So cup member 200 defines an interior surface 214 which abuts and seals against a face seal on a typical planar circular surface of distally projecting sealing post 36 and is arranged so that the flow of product fluid (e.g., 35) flows into and through annular lumen into the fluid feed or input channel 33 and then flows distally each of the interaction regions 210 defined in cup member 200. The cup-shaped nozzle member's cylindrical sidewall 202 has an open proximal end 204 defining the upstream end of an interior volume 206.

Nozzle member sidewall 202 terminates distally in a substantially circular distal end wall interior surface 214 and the exterior or distal end wall surface 216 has (in the illustrated example) three outlets or exit apertures 234A, 234B, 234C which provide fluid communication between the interior 206 and exterior of the cup shaped nozzle member 200. There may be more than three exit orifices in a nozzle assembly or for use with a dispenser, but for purposes of describing the nozzle geometry of the present application, the exemplary nozzle member 200 includes at least the three illustrated exit orifices 234A, 234B, 234C passing through distal end wall 212.

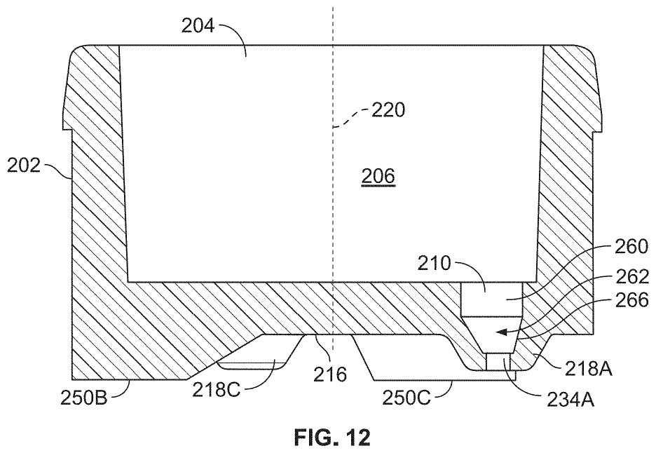

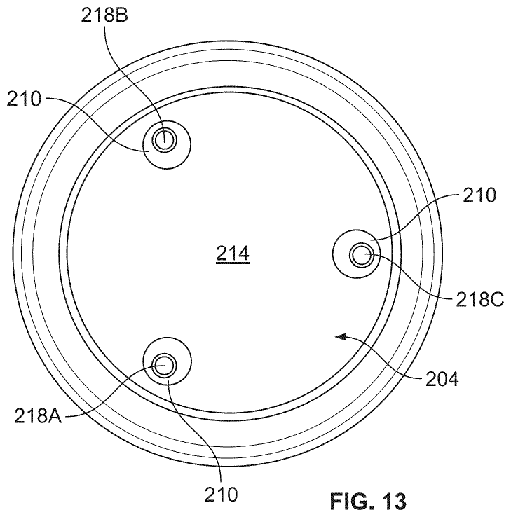

Defined in the interior surface 214 are the jet-spray generating structures which each include at least a first, second, and third fluid channel interaction region 210A, 210B, 210C which includes a proximal cylindrical lumen segment 260 and an axially aligned distally narrowing contiguous region 262 defined by a asymmetrical frusto-conical converging fluid feed channel wall segments 264, 266 converging at an interior wall convergence angle and which terminates distally in its throat/outlet/orifice lumen having an axially aligned distally aimed throat length. The protuberance length may be greater than the throat length. The protuberance diameter is greater than the throat diameter. Each throat/outlet/orifice lumen provides fluid communication between its interaction region 210 and its outlet orifice 234 which opens to ambient space from the distal surface of its distally projecting protuberance end wall. Each distally projecting protuberance (e.g., 218A, 218B, 218C) has a circular planar or distal annular surface having a diameter which terminates radially in a rounded shoulder sidewall segment to define distal protuberance shoulder diameter (as best seen in FIG. 12).

The proximal lumen segment 260 may be generally cylindrical and include a length that extends from the interior surface 214 through a portion of the distal end wall 212. The lumen segment 260 may abut the axially aligned distally narrowing contiguous region 262 at a point within the distal end wall 212 before the protuberance extends from the outer surface 216 of the distal end wall 212. This configuration can be viewed in FIG. 12. Notably, the asymmetry of the fluid feed channel wall segments 264, 266 allow for a resultant spray that diverges from central axis 220. Here the angle of wall segment 264 is greater than the angle of wall segment 266 which causes such divergent spray. This disclosure contemplates asymmetric wall segments that causes a convergent spray wherein the angel of wall segment 264 si less than the angel of wall segment 266 (not shown).

The configuration of the inner geometry of the interaction region 210 and the throat 234 may play a functional role in the performance of spraying viscous fluids. The portion of the interaction region defined by the lumen segment 260 may have a length that is greater than a length of the distally narrowing contiguous region 262. While the length of the distally narrowing contiguous region 2622 may be greater than a length of the throat/outlet/orifice 234. The resulting configuration provides for a geometry of the protuberance 218 having a throat length that is of a small length relative to the remaining portions of the cup shaped nozzle 200 and such a configuration is a challenge to create, particularly when mass produced by injection molding. However, other methods of fabrication are contemplated by this disclosure, including additive manufacturing or 3D printing.

Further, the asymmetry of such internal geometry at each exit orifice is defined around a diverging orifice axis which is not parallel with first central longitudinal spray axis 220 and provides fluid communication between said nozzle member's interior fluid channel 206 and the ambient space beyond the distal end wall surface 216. As best seen in FIGS. 11 and 12, each exit orifice (e.g., 234A) is a non-symmetrical cylindrical lumen with a throat/outlet/orifice internal diameter dimension that is axially offset or angled with its corresponding interaction region defined in interior end wall surface 214.

Each of the three nozzle orifices is fed by a dedicated and axially mis-aligned interaction region defined in the interior surface 214 of the distal wall 212 to provide a jet spray generating structure which includes distinct, contiguous fluid feed channel wall segments.

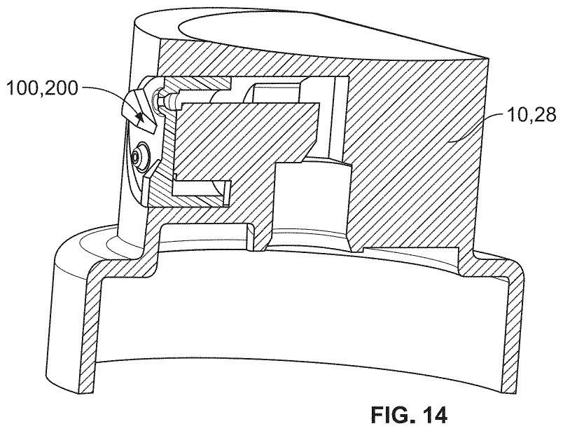

FIG. 14 is a perspective view in cross-section of an embodiment of a cup-shaped nozzle member 100, 200, 300 attached to a spray assembly 10, 28 according to the present disclosure.

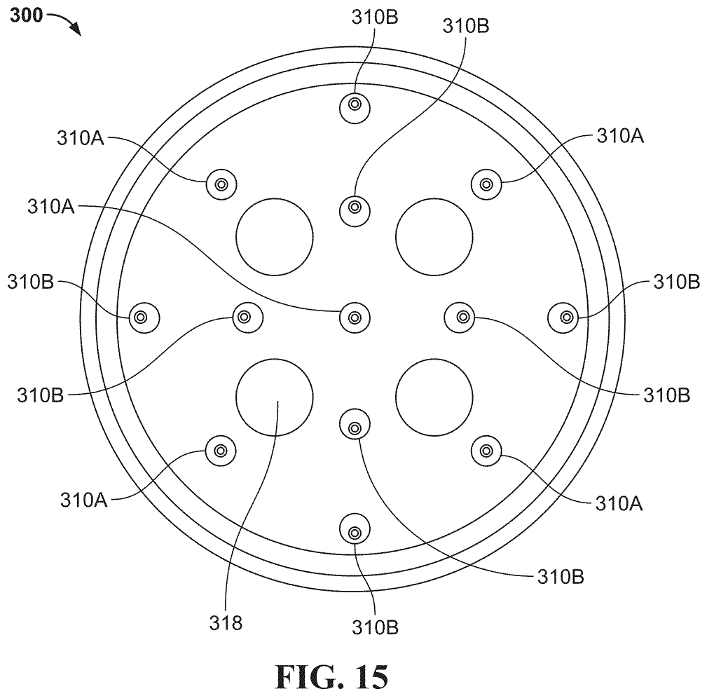

FIG. 15 is a front plan view of another embodiment a cup-shaped nozzle member according to the present disclosure. In this embodiment, the nozzle member 300 includes a plurality of exit orifices 334 without corresponding distally projecting protuberances. However, each exit orifices 334 includes a corresponding interaction region 310A or 310B configured in a particular arrangement. Notably, interaction region 310A are symmetrical an comparable to interaction region 110 described above. While interaction regions 310B are configured in asymmetrical shapes and comparable to the interaction region 210. The exit orifices 334 are each arranged in a particular configuration to provide for a combination of converging, diverging, or straight sprays of viscous fluid therefrom. FIG. 14 includes a pattern of thirteen exit orifices 334. Further

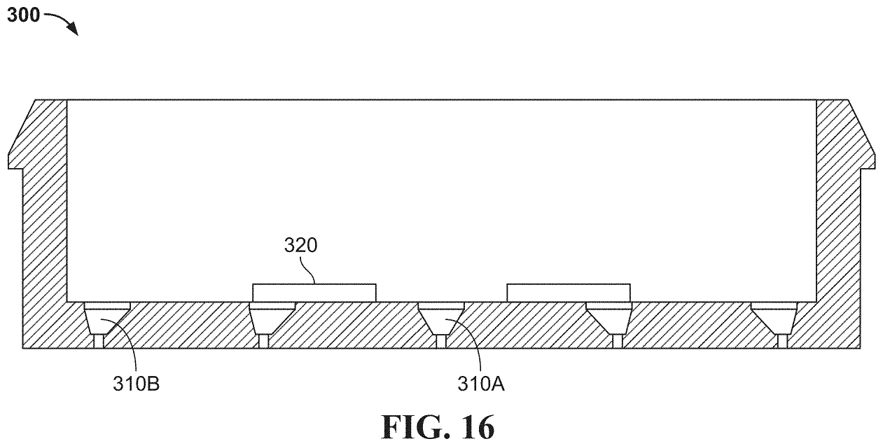

FIG. 16 a cross sectional view of the cup-shaped nozzle member of FIG. 15. Here, internal protuberances 320 are illustrated extending from an inner surface 314 of a distal end wall 312. The internal protuberances 320 may be shaped to abut against a sealing post 36 of a fluid device 10, 28 to allow for fluid to travel distally and radially about the sealing post 36 to reach the exit orifices 334 particularly located about the end surface of the sealing post 36. The internal protuberances 320 may be generally disc shaped but could have any other shape to allow for the flow of viscous fluid in communication with the inner exit orifices 334.

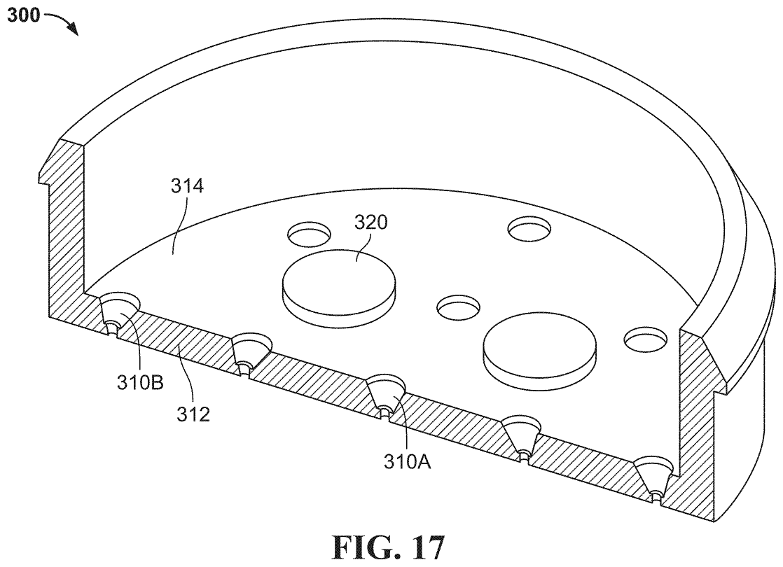

FIG. 17 is a partial perspective view of the cup-shaped nozzle member of FIG. 15. Notably, in this embodiment, there are no distally projecting ribs, however, it is contemplated that both distally projecting protuberances as well as distally projecting ribs may be incorporated into such a nozzle assembly.

Having described preferred embodiments of new and improved nozzle configurations and methods for generating uniform sprays of viscous fluids, it is believed that other modifications, variations and changes will be suggested to those skilled in the art in view of the teachings set forth herein. It is therefore to be understood that all such variations, modifications and changes are believed to fall within the scope of the present application.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

Having thus described the application, I claim:

1. A cup shaped nozzle member and dispensing package assembly for dispensing or spraying a pumped or pressurized fluid drawing from a transportable container to generate a spray of fluid, comprising;
(a) an actuator body having a distally projecting sealing post having a post peripheral wall terminating at a distal or outer face, said actuator body including a fluid passage communicating with a lumen;
(b) a cup-shaped nozzle member mounted in said actuator body having a peripheral wall extending proximally into a bore in said actuator body radially outwardly of said sealing post and having a distal end wall comprising an inner surface opposing said sealing post to define a fluid channel, said cup-shaped nozzle member including a plurality of interaction chambers defined within the distal end wall wherein each interaction chamber defines a fluid channel that terminates distally in an exit orifice;
(c) said interaction chambers being in fluid communication with said actuator body's fluid passage;
(d) wherein a first exit orifice has a selected diameter and is defined in a first distally projecting protuberance having a selected protuberance length and a selected protuberance diameter; and
(e) at least one distally projecting platform rib member spaced from and proximate to said first discharge orifice along an outer surface of the distal end wall, wherein said distally projecting platform rib member has a selected distally projecting length which is at least as great as the length of the first distally projecting protuberance.

2. The cup shaped nozzle member and dispensing package assembly of claim 1, wherein said cup shaped member includes three exit orifices each aimed from distally projecting protuberances which are radially arrayed on the distal end wall.

3. The cup shaped nozzle member and dispensing package assembly of claim 2, further comprising three distally projecting protective ribs.

4. The cup shaped nozzle member and dispensing package assembly of claim 2, wherein said cup shaped nozzle member is configured to spray viscous fluid for higher viscosity fluid over 50 cP having an inlet pressure of approximately 30 psi.

5. The cup shaped nozzle member and dispensing package assembly of claim 1, wherein the plurality of exit outlets have a throat diameter between about 0.005″ and 0.010″, separated by distally projecting protuberances which distally offset the exit orifices from a plane of the outer surface of the distal end wall, to reduce the presence of the residual fluid film directly on or around the exit outlet.

6. The cup shaped nozzle member and dispensing package assembly of claim 5, wherein said cup shaped nozzle member includes a substantially cylindrical sidewall that surrounds a central longitudinal spray axis aligned with said sealing post member;
wherein said sidewall terminates distally in the distal end wall having an interior surface with three distally aimed exit outlets and interaction chambers wherein each provide fluid communication between an interior and exterior of the nozzle member.

7. The cup shaped nozzle member and dispensing package assembly of claim 1, wherein said interaction region includes a proximal lumen segment and an axially aligned, distally narrowing, contiguous region defined by a converging fluid feed channel wall segment that terminates distally in said exit outlet, the exit outlet having a throat length;
wherein said interaction region is at least partially defined within said distally projecting protuberance such that the distally projecting protuberance includes a distal annular surface having a diameter which terminates radially in a rounded shoulder sidewall segment to define a protuberance length and a protuberance diameter.

8. The cup shaped nozzle member and dispensing package assembly of claim 7, wherein said proximal lumen segment is generally cylindrical and includes a length that extends from the interior surface through a portion of the distal end wall.

9. The cup shaped nozzle member and dispensing package assembly of claim 8, wherein said lumen segment is adjacent to the axially aligned, distally narrowing contiguous region at a position within the distal end wall before the protuberance extends from the outer surface of the distal end wall.

10. The cup shaped nozzle member and dispensing package assembly of claim 9, wherein said fluid feed channel wall segment is symmetrically shaped or frusto-conically shaped.

11. The cup shaped nozzle member and dispensing package assembly of claim 9, wherein said fluid feed channel wall segment includes an asymmetric shape.

12. A cup-shaped nozzle member configured to dispense viscous fluids from a dispensing package assembly, the cup-shaped nozzle member comprising:
a cylindrical sidewall that defines an interior volume and extends from a proximal open end to a distal end wall, the distal end wall comprising;
an inner surface including a plurality of interaction chambers defined within the distal end wall wherein each interaction chamber defines a fluid channel that terminates distally in an exit orifice, said interaction chambers being in fluid communication with said interior volume;
wherein a first exit orifice has a selected diameter and is defined in a first distally projecting protuberance having a selected protuberance length and a selected protuberance diameter; and
at least one distally projecting platform rib member spaced from and proximate to said first exit orifice along an outer surface of the distal end wall, wherein said distally projecting platform rib member has a selected distally projecting length, which is at least as great as the length of the first distally projecting protuberance.

13. The cup shaped nozzle member of claim 12, wherein the plurality of exit outlets have a throat diameter between about 0.005″ and 0.010″, and the projecting protuberances distally offset the exit orifices from a plane of the outer surface of the distal end wall to reduce the presence of the residual fluid film directly on or around the exit outlet.

14. The cup shaped nozzle member of claim 13, wherein said interaction region includes a proximal lumen segment and an axially aligned distally narrowing contiguous region defined by a converging fluid feed channel wall segment that terminates distally in said exit outlet, the exit outlet having a throat length;
wherein said interaction region is at least partially defined within said distally projecting protuberance such that the distally projecting protuberance includes a distal annular surface having a diameter which terminates radially in a rounded shoulder sidewall segment to define a protuberance length and a protuberance diameter.

15. The cup shaped nozzle member of claim 14, wherein said proximal lumen segment is generally cylindrical and includes a length that extends from the interior surface through a portion of the distal end wall.

16. The cup shaped nozzle member of claim 15, wherein said lumen segment is adjacent to the axially aligned distally narrowing contiguous region at a position within the distal end wall before the protuberance extends from the outer surface of the distal end wall.

17. The cup shaped nozzle member of claim 16, wherein said fluid feed channel wall segment is symmetrically shaped or frusto-conically shaped.

18. The cup shaped nozzle member of claim 16, wherein fluid feed channel wall segment includes an asymmetric shape.

19. The cup shaped nozzle member of claim 16, wherein the portion of the interaction region defined by the lumen segment includes a length that is greater than a length of the distally narrowing contiguous region;
wherein the length of the distally narrowing contiguous region is greater than a length of the throat length.

20. A cup-shaped nozzle member configured dispense viscous fluids from a dispensing package assembly, the cup-shaped nozzle member comprising:
a cylindrical sidewall that defines an interior volume and extends from a proximal open end to a distal end wall, the distal end wall comprising;
an inner surface including a plurality of interaction chambers defined within the distal end wall wherein each interaction chamber defines a fluid channel that terminates distally in an exit orifice, said interaction chambers being in fluid communication with said interior volume;
wherein a first exit orifice has a selected diameter and is defined in a first distally projecting protuberance having a selected protuberance length and a selected protuberance diameter;
at least one distally projecting platform rib member spaced from and proximate to said first exit orifice along an outer surface of the distal end wall, wherein said distally projecting platform rib member has a selected distally projecting length which is at least as great as the length of the first distally projecting protuberance;
the distally projecting rib is shaped to include a platform portion adjacent to a ramp portion wherein the platform portion has a greater width than the ramp portion and includes a generally tapered profile;
wherein the distally projecting platform rib member is aligned along a common axis with a first outlet protuberance.
